(19) United States
(12) Patent Application Publication
(10) Pub. No.: US 2007/0036184 A1
(43) Pub. Date: Feb. 15, 2007

(54) Laser apparatus for material processing

(76) Inventors: Stuart Wayne Woods, Hampshire (GB); David Gareth Parker, Hampshire (GB); Andrew Paul Appleyard, Hampshire (GB); Malcolm Paul Varnham, Hampshire (GB)

Correspondence Address: John S Reid;Reidlaw, 1926 S Valleyview Lane, Spokane, WA, 99212-0157, US

(21) Appl. No.: 10/554,834

(22) PCT Filed: Apr. 29, 2004
(86) PCT No.: PCT/GB04/01865

§ 371 Date: Oct. 28, 2005

(30) Foreign Application Priority Data
Apr. 29, 2003 (GB) 0309674.0

(51) Int. Cl. H01S 3/11; B23K 26/00

(52) U.S. Cl. 372/10; 219/121.6

(57) ABSTRACT

Apparatus for material processing, which apparatus comprises a rare-earth doped fibre (1), a laser diode source (2), a short pulse laser (18) and a controller (9), wherein the rare-earth doped fibre (1) is pumped by the laser diode source (2) to provide optical radiation (10), and the optical radiation (10) emitted by the rare-earth doped fibre (1) is combined with optical radiation (11) emitted by the short pulse laser (18), the apparatus being characterised in that the controller (9) synchronizes the optical radiation (10) emitted from the rare-earth doped fibre (1) with the optical radiation (11) emitted by the short pulse laser (18) to provide a plurality of pulses (5) comprising a pre-pulse (21) and a main pulse (22), the average peak power (23) of the pre-pulse (21) being greater than the peak power (24) of the main pulse (22).

### FIELD OF INVENTION

This invention relates to apparatus for material processing. The apparatus can take various forms, for example laser welding apparatus for welding sheet metal parts of an automobile, an aeroplane, a helicopter or a space vehicle, and laser apparatus for cutting and machining.

### BACKGROUND TO THE INVENTION

Lasers are used extensively in material processing applications such as welding, cutting and marking. Traditional lasers include carbon dioxide lasers and yttrium alumirium garnet (YAG) lasers. Carbon dioxide and lamp pumped YAG lasers typically consume large amounts of electrical power and typically need separate, expensive refrigerated chillers or water cooling units and corresponding cooler controller and power supplies to maintain the cooling. All this equipment is expensive to run and takes up large floor areas.

For this reason, there has been a trend over the last decade to introduce laser diode pumped lasers, which offer significant advantages in terms of power consumption, and reliability. Examples of these laser diode pumped lasers include laser diode pumped YAG lasers and laser diode pumped Vanadate lasers. These diode pumped solid-state lasers consume significantly less power than their lamp-pumped equivalents, can be operated without external chillers, and have significantly improved reliability.

A limitation of the diode pumped solid state lasers is that it is difficult to achieve the long-pulse operation required in applications such as welding thin sheet metal. For such applications, lamp pumped lasers are still the laser of choice, despite the significant drawbacks of high-maintenance because the lamps have to be replaced on a regular basis, high infrastructure costs because of electrical power and external chiller units, and large floor area siting requirements.

There is a need for apparatus for material processing, for example laser welding, cutting and micromachining, that is less expensive, that consumes less power, that does not have high-maintenance costs, and yet can provide the relatively long pulses required for applications such as welding, cutting and machining.

It is an aim of the present invention to provide apparatus for material processing that reduces the above mentioned problems.

### SUMMARY OF THE INVENTION

According to a non-limiting embodiment of the present invention, there is provided apparatus for material processing, which apparatus comprises a rare-earth doped fibre, a laser diode source, a short pulse laser and a controller, wherein the rare-earth doped fibre is pumped by the laser diode source to provide optical radiation, and the optical radiation emitted by the rare-earth doped fibre is combined with optical radiation emitted by the short pulse laser, the apparatus being characterised in that the controller synchronizes the optical radiation emitted from the rare-earth doped fibre with the optical radiation emitted by the short pulse laser to provide a plurality of pulses comprising a pre-pulse and a main pulse, the average peak power of the pre-pulse being greater than the peak power of the main pulse.

The apparatus of the invention allows the use of short pulse lasers that utilize stored energy to output pulses having peak powers significantly higher than the power supplied by the laser diode source. The apparatus thus provides savings in equipment costs (dominated by the price of laser diodes), as well as reduced infrastructure and utility costs.

The short pulse laser may be a Q-switched laser. The Q-switched laser may be an optical fibre Q-switched laser. The short pulse laser may be a master oscillator power amplifier.

The rare-earth doped fibre and laser diode source may be in the form of a cladding-pumped fibre laser.

The optical radiation from the rare earth doped fibre and the optical radiation from the short-pulse laser may be combined in parallel. Alternatively, the optical radiation from the rare earth doped fibre and the optical radiation from the short-pulse laser may be combined in series.

The apparatus may be configured to emit pulse energies between 0.01 mJ and 10 J. The pulses may have lengths between 1 μs and 10,000 μs. The pulse repetition frequency may be between 1 Hz and 10 kHz.

The rare-earth doped fibre and laser diode source may be in the form of a power amplifier configured to amplify the output of the short pulse laser. The short pulse laser may be a semiconductor laser diode. The apparatus may be configured to emit pulses having pulse energies between 0.01 mJ and 1 mJ. The pulses may have lengths between 10 ns and 10 μs. The pulse repetition frequency may be between 10 kHz and 500 kHz.

The main pulse may have a substantially uniform peak power. The shape of a falling edge of the main pulse may be different from the shape of a rising edge of the pre-pulse.

The apparatus may include a modulator for modulating the laser diode source. The modulator may comprise a switch. The switch may divert at least 10 A of electrical current into the laser diode source. The electrical current may be switched in a time period less than 500 ns. The electrical current may be switched in a time period less than 250 ns. The electrical current may be switched in a time period less than 100 ns.

The laser diode source may be located remotely from the rare-earth doped fibre.

The laser diode source may comprise an array of single emitters, a semiconductor laser bar, a semiconductor laser stack or an array of vertical cavity surface emitting lasers.

The apparatus may be in the form of laser apparatus for welding sheet metal. The apparatus may alternatively be in the form of laser welding apparatus for welding sheet metal parts of an automobile, an aeroplane, a helicopter, or a space vehicle. The apparatus may alternatively be in the form of laser apparatus for cutting and machining.

### BRIEF DESCRIPTION OF THE DRAWINGS

Embodiments of the invention will now be described solely by way of example and with reference to the accompanying drawings in which:

FIG. 1 shows apparatus for material processing;

FIG. 2 shows a pulse comprising a pre-pulse;

FIG. 3 shows a switch;

FIG. 4 shows a Q-switched laser and a cladding pumped fibre laser combined in parallel;

FIG. 5 shows a Q-switched laser and a cladding pumped fibre laser combined in series; and

FIG. 6 shows a master oscillator power amplifier.

### DETAILED DESCRIPTION OF PREFERRED EMBODIMENTS OF THE INVENTION

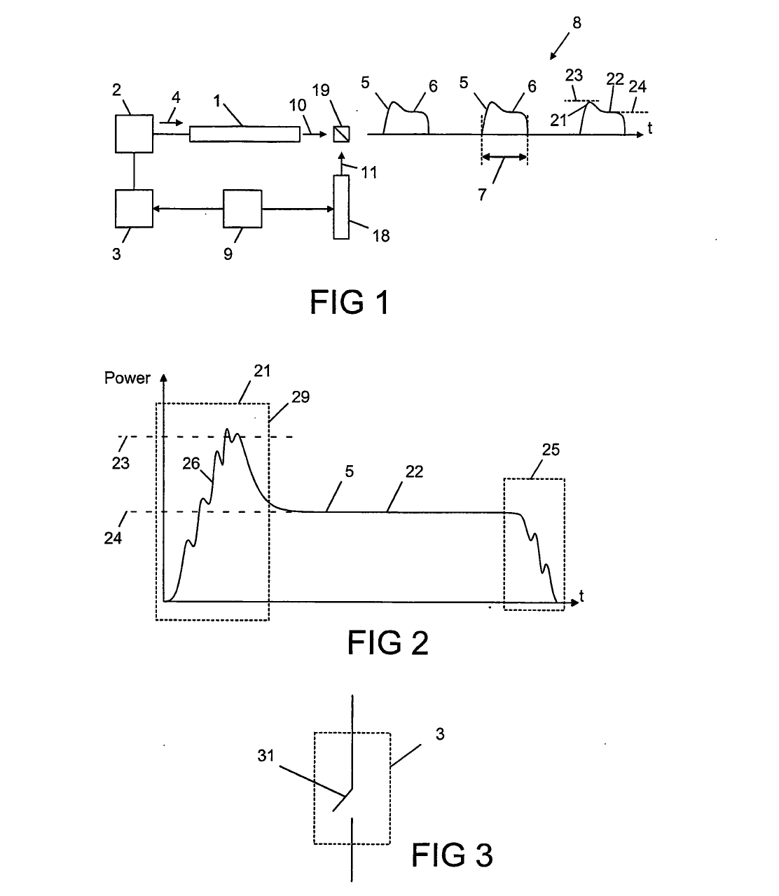

Referring to FIG. 1, there is shown apparatus for material processing comprising a rare-earth doped fibre 1, a laser diode source 2, a short pulse laser 18 and a controller 9, wherein the rare-earth doped fibre 1 is pumped by the laser diode source 2 to provide optical radiation 10, and the optical radiation 10 emitted by the rare-earth doped fibre 1 is combined with optical radiation 11 emitted by the short pulse laser 18, the apparatus being characterised in that the controller 9 synchronizes the optical radiation 10 emitted from the rare-earth doped fibre 1 with the optical radiation 11 emitted by the short pulse laser 18 to provide a plurality of pulses 5 comprising a pre-pulse 21 and a main pulse 22, the average peak power 23 of the pre-pulse 21 being greater than the peak power 24 of the main pulse 22.

The optical radiation 10 and the optical radiation 11 are shown as being combined by a coupler 19. The coupler 19 may be a dichroic mirror, a mirror, a half-silvered mirror, a beam combiner, a polarisation beam combiner, or an optical waveguide coupler.

Also shown in FIG. 1 is a modulator 3 for modulating the optical radiation 10 emitted by the rare-earth doped fibre 1. The modulator 3 may be a modulator that modulates the output of the laser diode source 2. Modulation can be achieved by direct current modulation of the laser diode source or by placing an optical modulator between the laser diode source 2 and the rare-earth doped fibre 1. The controller 9 is shown as providing control inputs to the modulator 3 and to the short pulse laser 18. The control function provided by the controller 9 may be derived from externally provided signals or by the provision of feedback—for example as derived from process monitoring equipment such as cameras, thermal detectors, chemical sensors or optical detectors. The controller 9 may be an electronic controller which may include one or more computers or microprocessors.

The pulses 5 can have pulse energies 6 from 0.01 mJ to 10 J, pulse lengths 7 between 1 ns and 10,000 μs, and a pulse repetition frequency 8 between 1 Hz and 500 kHz.

FIG. 2 shows a pulse 5 that comprises a pre-pulse 21 and a main pulse 22, wherein the average peak power 23 of the pre-pulse 21 is greater than the peak power 24 of the main pulse 22. The pre-pulse 21 has an energy 29. The main pulse 22 preferably has a substantially uniform peak power 24. The shape of the falling edge 25 of the main pulse 22 can be the same or be different from the shape of the rising edge 26 of the pre-pulse 21. In many material processing applications such as welding thin sheets of metal, the shape of the falling edge 25 is made to be deliberately different from the shape of the rising edge 26. In many material processing applications, the pre-pulse 21 is required to have a higher average peak power 23 with sufficient energy 29 in order to initiate a process (such as the initiation of a weld in welding applications). The process is then continued with the main pulse 22, and brought to a halt with the falling edge 25 of the main pulse 22. The pre-pulse 21 can be 20 ns to 1 μs long. The average peak power 23 of the pre-pulse 21 can be 100 W to 100,000 W. The peak power 24 of the main pulse 22 can be 50 W to 10,000 W.

FIG. 3 shows a modulator 3 that comprises a switch 31. The choice of switch 31 is important for material processing applications since it is often necessary to divert between 1 A and 100 A of electrical current into the laser diode source within relatively short timescales, such as between 50 ns and 500 ns. A suitable switch 31 is a PCO-6140 pulsed/CW laser diode driver module from Directed Energy Incorporated which can deliver 60 A with a rise time (10% to 90%) adjustable from less than 50 ns to greater than 40 μs.

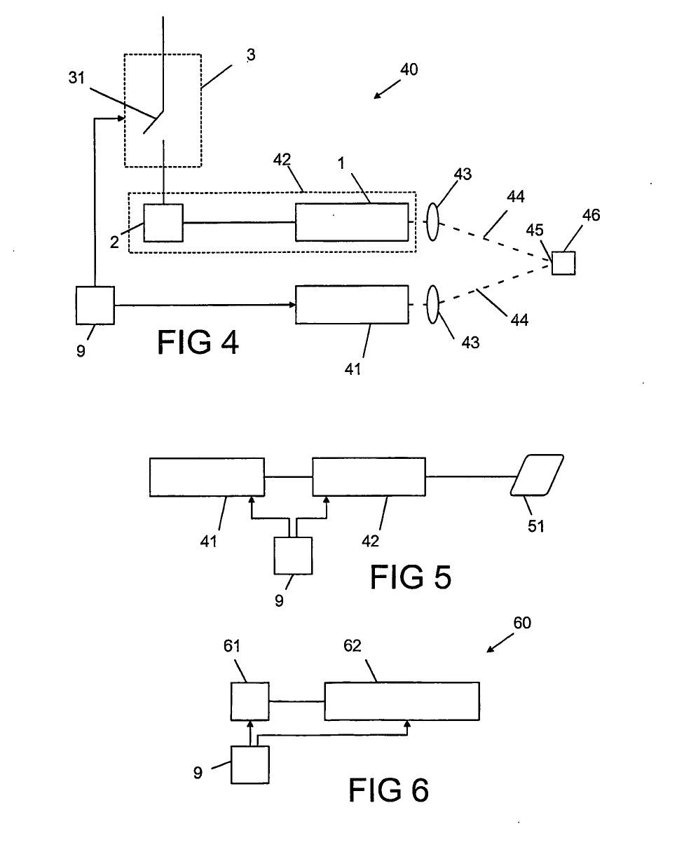

FIG. 4 shows a fibre laser system 40 that comprises a Q-switched laser 41 and a cladding pumped fibre laser 42. The Q-switched laser 41 can be a solid state Q-switched laser or a Q-switched fibre laser. The cladding pumped fibre laser 42 comprises the rare earth doped fibre 1 and the laser diode source 2. The outputs of the Q-switched laser 41 and the cladding pumped fibre laser 42 are shown combined in parallel using lenses 43 such that their laser outputs 44 combine together at a location 45 such as the surface of a material 46. Alternatively, the Q-switched laser 41 and the cladding pumped fibre laser 42 can be combined via a dichroic filter. The Q-switched laser 41 provides much of the energy in the pre-pulse 21 and the cladding pumped fibre laser 42 provides the energy in the main pulse 22. The cladding pumped fibre laser 42 can advantageously utilize the switch 31 in order to switch on the laser diode source 2.

FIG. 5 shows the outputs of the Q-switched laser 41 and the cladding pumped fibre laser 42 combined in series. It is advantageous when combining the outputs in series for the Q-switched laser 41 and the cladding pumped fibre laser 42 to have different lasing wavelengths, such wavelengths being determined for example by dichroic mirrors or gratings. Also shown in FIG. 5 is sheet metal 51 such as found in the manufacture of an automobile, an aeroplane, a helicopter, or a space vehicle.

Referring to FIGS. 4 and 5, the combination of the Q-switched laser 41 and the cladding pumped laser 42 combines the energy storage advantages of the Q-switched laser 41 with the high-power advantages of the cladding pumped fibre laser 42. An alternative configuration based only on cladding pumped fibre lasers 42 may suffer a disadvantage in having to utilize many more pump diodes in order to achieve the higher peak power pre-pulse 21. The Q-switched laser 41 can be replaced by a master oscillator power amplifier or other optical sources capable of storing energy supplied by pumps and releasing the stored energy in a pulse having a higher peak power than the power supplied by the pumps as well as sufficient energy within the pulse to initiate the material process.

An advantage of the arrangements shown in FIGS. 4 and 5 is that it can be more economic to combine a stored energy source and a cladding pumped fibre laser to provide the pulse shape of FIG. 2. This is because the high peak power and high energy content of the pre-pulse 21 can be obtained with a source comprising lower power pumps than would be required if the pre-pulse 21 were obtained from a cladding pumped laser alone. For example, if the average peak power 23 were 10 kW and the peak power 24 of the main pulse were 1 kW, then single cladding pumped fibre laser solution would require approximately 20 kW of pump power (assuming 50% optical to optical efficiency). The embodiments shown in FIGS. 4 and 5 would be achievable with a stored energy source (to provide the 10 kW average peak power 23) comprising 1 W to 200 W of pump power (assuming a relatively low repetition rate such as 0.1 Hz to 1000 Hz), and a cladding pumped fibre laser comprising 2 kW of pump power (assuming 50% optical efficiency). The advantages become even more pronounced with 5 kW or 10 kW fibre lasers used in processes such as welding that require a high-energy, high power pre-pulse 21. Fibre lasers 42 having various output powers are commercially available from companies such as JDS Uniphase and Southampton Photonics, Inc.

A further advantage of the arrangements shown in FIGS. 4 and 5 is that the pre-pulse 21 can be controlled independently of the main pulse 22. This facilitates optimisation of process parameters and introduction of the process into manufacturing. Thus the average peak power 23 and energy 29 of the pre-pulse 21 can be tailored for process initiation of different materials by optimising the Q-switched laser 41 independently of the cladding pumped fibre laser 42. The Q-switched laser 41 can be optimised by varying the pump power, intra-cavity losses and wavelength. Additionally, Q-switched lasers 41 having different cavity lengths can also be used. Even more flexibility is achievable with a master oscillator power amplifier to replace the Q-switched laser 41, particularly if the master oscillator power amplifier is seeded with an electrically-modulated semiconductor diode laser. Thus the embodiments provide much greater flexibility than is achievable from use of relaxation oscillations on a pump-modulated fibre laser.

FIG. 6 shows apparatus comprising a fibre laser in the form of a master oscillator power amplifier 60. The master oscillator power amplifier 60 has an oscillator 61 and a power amplifier 62. The power amplifier 62 comprises the rare-earth doped fibre 1 and the laser diode source 2. The oscillator 61 can be a Q-switched laser, and the power amplifier 62 can comprise at least one fibre amplifier which may include at least one of pre-amplifiers, core-pumped fibre amplifiers, and cladding-pumped fibre amplifiers which can be single mode or multimode. The oscillator 61 can be a semiconductor laser diode (such as a distributed feedback semiconductor laser) or a fibre laser. Examples of fibre amplifiers that may be used are disclosed in U.S. Pat. No. 6,288,835 which is hereby incorporated herein by reference. The master oscillator power amplifier 60 can be used to replace the Q-switched laser 41 in FIGS. 4 and 5. Alternatively, the master oscillator power amplifier 60 can be used to generate the entire pulse 5 shown in FIG. 2 which is advantageous for either high-repetition rate systems (10 kHz to 250 kHz) operating with narrower pulses (1 ns to 1 μs), or with lower average peak power 23 systems where the economic justification for using a Q-switched laser 41 with a cladding pumped fibre laser 42 does not apply.

Advantageously, the controller 9 is arranged to control the average peak power 23, energy 29 and shape of the pre-pulse 21, the power 24 of the main pulse 22, and the shape of the falling edge 25. This enables the laser pulses 5 emitted by the master oscillator power amplifier 60 to be shaped with relatively precise profiles.

The embodiments shown in FIGS. 4, 5 and 6 are particularly useful for laser welding apparatus for welding sheet metal parts of an automobile, an aeroplane, a helicopter, or a space vehicle, and laser apparatus for cutting and machining. By cutting, it is meant both pulse ablation as well as fine cutting achieved via melting (as opposed to shorter pulse ablation cutting). The apparatus of the invention has particular relevance for welding sheet metal having a thickness of 0.75 m to 1.5 mm, as well as welding, cutting and machining fine mechanical parts such as watches, jewellery, electronics, and medical components (implants, pacemakers, stents etc) where the metal thickness can be less than 0.3 mm, and often less than 0.1 mm.

Referring back to FIG. 1, the laser diode source 2 may be located remotely from the fibre laser system 1. This has advantages in industrial welding facilities because the fibre laser system 1 can be placed near the welding tools, whereas the pump diodes can be placed near service corridors to facilitate maintenance.

The laser diode source 2 can comprise an array of single emitters, a semiconductor laser bar, a semiconductor laser stack or an array of vertical cavity surface emitting lasers. The apparatus may comprise a plurality of laser diode sources 2 and modulators 3 in order to achieve the high powers from the cladding pumped fibre lasers 42.

It is to be appreciated that the embodiments of the invention described above with reference to the accompanying drawings have been given by way of example only and that modifications and additional components may be provided to enhance performance. Thus, for example, the apparatus of the invention may be laser welding apparatus for welding sheet metal parts of an automobile, an aeroplane, a helicopter or a space vehicle, or laser apparatus for cutting and machining.

The present invention extends to the above-mentioned features taken in isolation or in any combination.

1-28. (canceled)

29. Apparatus for material processing, comprising
a rare-earth doped fibre;
a laser diode source;
a short pulse laser; and
a controller, and wherein:
the rare-earth doped fibre is pumped by the laser diode source to provide optical radiation;
the optical radiation emitted by the rare-earth doped fibre is combined with optical radiation emitted by the short pulse laser;
the controller synchronizes the optical radiation emitted from the rare-earth doped fibre with the optical radiation emitted by the short pulse laser to provide a plurality of pulses comprising a pre-pulse and a main pulse, the average peak power of the pre-pulse being greater than the peak power of the main pulse.

30. Apparatus according to claim 29 wherein the short pulse laser is a Q-switched laser.

31. Apparatus according to claim 30 wherein the Q-switched laser is an optical fibre Q-switched laser.

32. Apparatus according to claim 29 wherein the short pulse laser is a master oscillator power amplifier.

33. Apparatus according to claim 29 wherein the rare-earth doped fibre and the laser diode source are in the form of a cladding-pumped fibre laser.

34. Apparatus according to claim 29 wherein the optical radiation from the rare earth doped fibre and the optical radiation from the short-pulse laser are combined in parallel.

35. Apparatus according to claim 1 wherein the optical radiation from the rare earth doped fibre and the optical radiation from the short-pulse laser are combined in series.

36. Apparatus according to claim 29 wherein the apparatus is configured to emit pulse energies between 0.01 mJ and 10 J.

37. Apparatus according to claim 36 wherein the pulses have lengths between 1 μs and 10,000 μs.

38. Apparatus according to claim 37 wherein the pulse repetition frequency is between 1 Hz and 10 kHz.

39. Apparatus according to claim 29 wherein the rare-earth doped fibre and the laser diode source are in the form of a power amplifier configured to amplify the output of the short pulse laser.

40. Apparatus according to claim 39 wherein the short pulse laser is a semiconductor laser diode.

41. Apparatus according to claim 29 wherein the apparatus is configured to emit pulse energies between 0.01 mJ and 1 mJ.

42. Apparatus according to claim 41 wherein the pulses have lengths between 10 ns and 10 μs.

43. Apparatus according to claim 41 wherein the pulse repetition frequency is between 10 kHz and 500 kHz.

44. Apparatus according to claim 29 wherein the main pulse has a substantially uniform peak power.

45. Apparatus according to claim 29 wherein the shape of a falling edge of the main pulse is different from the shape of a rising edge of the pre-pulse.

46. Apparatus according to claim 29 wherein the apparatus includes a modulator for modulating the laser diode source.

47. Apparatus according to claim 46 wherein the modulator comprises a switch.

48. Apparatus according to claim 47 wherein the switch diverts at least 10 A of electrical current into the laser diode source.

49. Apparatus according to claim 48 wherein the electrical current is switched in a time period less than 500 ns.

50. Apparatus according to claim 49 wherein the electrical current is switched in a time period less than 250 ns.

51. Apparatus according to claim 50 wherein the electrical current is switched in a time period less than 100 ns.

52. Apparatus according to claim 29 wherein the laser diode source is located remotely from the rare-earth doped fibre.

53. Apparatus according to claim 29 wherein the laser diode source comprises an array of single emitters, a semiconductor laser bar, a semiconductor laser stack or an array of vertical cavity surface emitting lasers.

54. Apparatus according to claim 29 and in the form of laser apparatus for welding sheet metal.

55. Apparatus according to claim 29 and in the form of laser welding apparatus for welding sheet metal parts of an automobile, an aeroplane, a helicopter, or a space vehicle.

56. Apparatus according to claim 29 and in the form of laser apparatus for cutting and machining.
